(19) United States
(12) Patent Application Publication
(10) Pub. No.: US 2007/0118574 A1
(43) Pub. Date: May 24, 2007

(54) Reorganizing data with update activity

(76) Inventors: William James Franklin, San Ramon, CA (US); Haakon Philip Roberts, San Jose, CA (US); James Zu-Chia Teng, San Jose, CA (US); Jay A. Yothers, Gilroy, CA (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 11/286,846

(22) Filed: Nov. 22, 2005

(51) Int. Cl. G06F 17/30

(52) U.S. Cl. 707/204

(57) ABSTRACT

Provided are a techniques for reorganizing data. Data is retrieved from an original data set and inserted into a shadow data set. A log record is read from an update log, wherein the log record includes a unique key identifying a data object and an indication of an activity associated with that data object. The activity associated with the data object is performed by determining whether the unique key is found in a shadow index for the shadow data set.

### BACKGROUND

1. Field

Embodiments of the invention relate to reorganizing data with update activity.

2. Description of the Related Art

A Relational DataBase Management System (RDBMS) uses relational techniques for storing and retrieving data in a relational database. Relational databases are computerized information storage and retrieval systems. Relational databases are organized into tables that consist of rows and columns of data. The rows may be called “tuples”, “records” or “rows”. A database typically has many tables, and each table typically has multiple records and multiple columns.

RDBMS software may use a Structured Query Language (SQL) interface. The SQL interface has evolved into a standard language for RDBMS software and has been adopted as such by both the American National Standards Institute (ANSI) and the International Standards Organization (ISO).

Customer business and application environments emphasize the requirement for continuous data availability. However, data may need to be reorganized, either for performance reasons, due to metadata changes or for physical space reclamation. As a result, data reorganization utilities provide the capability to reorganize data while maintaining near-full update activity against the data, and this capability may also be referred to as “online REORG”. An update activity may be described as an insert activity that inserts a data object into a database, a delete activity that deletes a data object from the data base or an update activity that modifies a data object in the database. A data object may be described as some element of the database (e.g., a row or a large object (“LOB”)). In particular, when an original data set is to be reorganized, data from the original data set is copied to form a shadow data set (i.e., a copy of the original data set) so that the shadow data set may be reorganized while the original data set is being accessed. During this copy operation, other changes may have been received, and information on these changes is stored in an update log. The update log may be described as storing information on update activity for a database. Also, the original data set may include all of the changes in the update log, but, some updates may be missed from the original copy of the original data set to the shadow data set. The update log is scanned and updates to the shadow data set are generated using the data stored in the update log. For a short period, updates to the data in the original data set being reorganized are denied to allow a log read process to complete reading the update log and updating the shadow data set, and then all access is denied as the shadow and original data sets are switched. Once the switch is done, the reorganization is completed.

There are several drawbacks to this solution. For example, this solution is complex and relies on regenerating data updates from an update log. Also, this solution requires logging of the actual data, so the solution may not work with structures for which logging of data is disabled, such as for Large Object (LOB) table spaces when no logging has been specified. Also, the solution requires a mapping table to map data entries in an original data set structure for the original data set to data entries in a shadow data set structure for the shadow data set.

Thus, there is a need in the art for an improved solution for reorganizing data with update activity that may be used for situations in which logging is enabled and situations in which logging is disabled.

### SUMMARY OF EMBODIMENTS OF THE INVENTION

Provided are a method, computer program product, and system for reorganizing data. Data is retrieved from an original data set and inserted into a shadow data set. A log record is read from an update log, wherein the log record includes a unique key identifying a data object and an indication of an activity associated with that data object. The activity associated with the data object is performed by determining whether the unique key is found in a shadow index for the shadow data set.

### BRIEF DESCRIPTION OF THE DRAWINGS

Referring now to the drawings in which like reference numbers represent corresponding parts throughout:

FIG. 1 illustrates details of a computer architecture in accordance with certain embodiments.

FIG. 2 illustrates logging in accordance with certain embodiments.

FIG. 3 illustrates processing for a reorganization of data in accordance with certain embodiments.

FIG. 4 illustrates unload phase processing in accordance with certain embodiments.

FIG. 5 illustrates log phase processing in accordance with certain embodiments. FIG. 5 is shown as FIGS. 5A-5E.

FIG. 6 illustrates switch phase processing in accordance with certain embodiments.

FIG. 7 illustrates termination phase processing in accordance with certain embodiments.

FIG. 8 illustrates an architecture of a computer system that may be used in accordance with certain embodiments.

### DETAILED DESCRIPTION

In the following description, reference is made to the accompanying drawings which form a part hereof and which illustrate several embodiments of the invention. It is understood that other embodiments may be utilized and structural and operational changes may be made without departing from the scope of the invention.

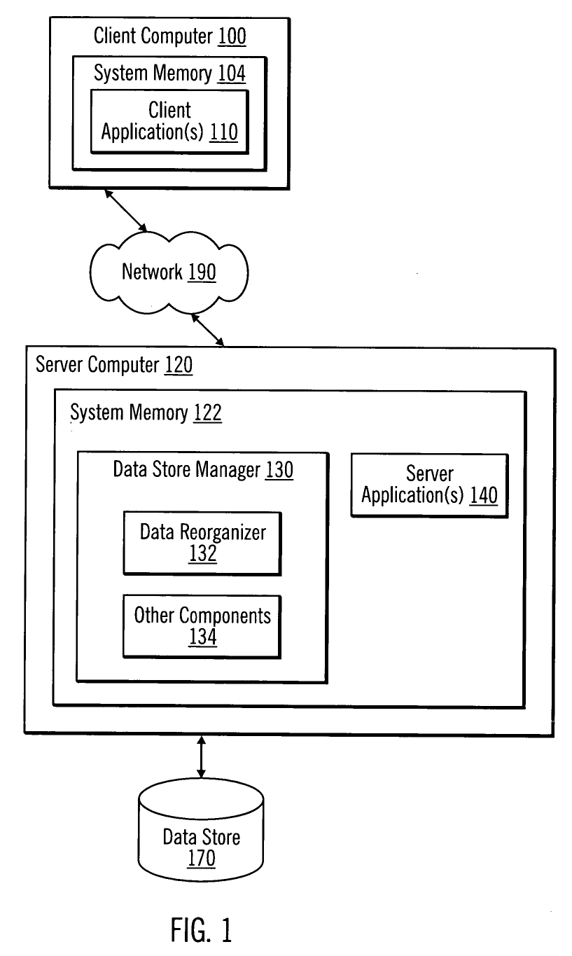

FIG. 1 illustrates details of a computer architecture in accordance with certain embodiments. A client computer 100 is connected via a network 190 to a server computer 120. The client computer 100 includes system memory 104, which may be implemented in volatile and/or non-volatile devices. One or more client applications 110 (i.e., computer programs) are stored in the system memory 104 for execution by a processor (e.g., a Central Processing Unit (CPU)) (not shown).

The server computer 120 includes system memory 122, which may be implemented in volatile and/or non-volatile devices. System memory 122 stores a data store manager 130 (e.g., a Relational DataBase Management System (RDBMS)) and one or more server applications 140. The data store manager 130 includes a data reorganizer 132 and may include one or more other components 134. These computer programs that are stored in system memory 122 are executed by a processor (e.g., a Central Processing Unit (CPU)) (not shown). The server computer 120 provides the client computer 100 with access to data in a data store 170.

In alternative embodiments, the computer programs may be implemented as hardware, software, firmware or a combination of any of these.

The client computer 100 and server computer 120 may comprise any computing device known in the art, such as a server, mainframe, workstation, personal computer, hand held computer, laptop telephony device, network appliance, etc.

The network 190 may comprise any type of network, such as, for example, a Storage Area Network (SAN), a Local Area Network (LAN), Wide Area Network (WAN), the Internet, an Intranet, etc.

The data store 170 may comprise an array of storage devices, such as Direct Access Storage Devices (DASDs), Just a Bunch of Disks (JBOD), Redundant Array of Independent Disks (RAID), virtualization device, etc.

Embodiments provide the ability to reorganize data, including structures (e.g., relational tables), for which no actual data is logged during insert, update or delete activity, while providing data availability.

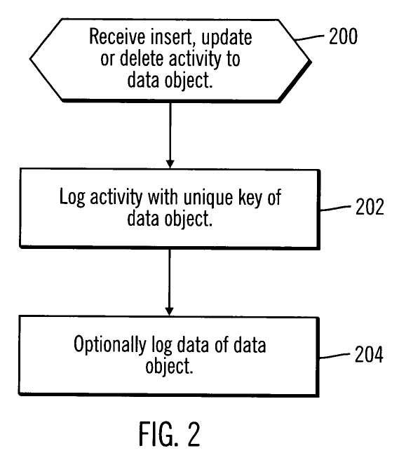

FIG. 2 illustrates logging in accordance with certain embodiments. Logging may be described as adding an entry to an update log indicating insert, update or delete activities. Control begins in block 200 with the data store manager 130 receiving insert, update or delete activity to data object. The update activity may be described as a delete activity followed by an insert activity. In block 202, the data store manager 130 (or a logging component 134 of the data store manager 130) logs the activity with a unique key of the data object. In block 304, the data store manager 130 optionally logs the data of the data object. For example, if an insert activity for a large object is received, the update log is modified to include an entry indicating the unique key of the data object and that there has been an insert activity for this data object. In block 204, optionally, data may be logged.

Thus, embodiments provide a unique key for each data object, and the key is logged when update activity occurs against the data entry. Unlike conventional solutions, with embodiments, there is no requirement for the logging of the data of the data object.

With embodiments, existing data is retrieved (or “extracted”) from the original data set and inserted into a shadow data set. The update log is then read. Any log records encountered for insert activity or update activity results in a corresponding data entry being retrieved from the original data set and inserted into the shadow data set, throwing away the old entry in the shadow data set, if necessary. Any log records encountered for delete activity results in a corresponding data entry being deleted from the shadow data set.

Embodiments retrieve the necessary data from the original data set as the update log is processed. If an entry cannot be found in the original data set, then it is ignored because the assumption is that it has been subsequently deleted. In certain embodiments, activities found on the update log may or may not be reflected in the shadow data set, however, at the end of the data reorganization, the original data set and shadow data set are consistent.

Embodiments rely on update log records uniquely identifying each data entry being updated, inserted or deleted, but do not require the data itself to be present in the update log. For example, embodiments provide a REORG SHRLEVEL CHANGE solution for large objects (LOBS) in a DB2® for z/OS® system (available from International Business Machines Corporation). The indication of CHANGE in the REORG SHRLEVEL CHANGE solution indicates that the reorganization described herein is to be used.

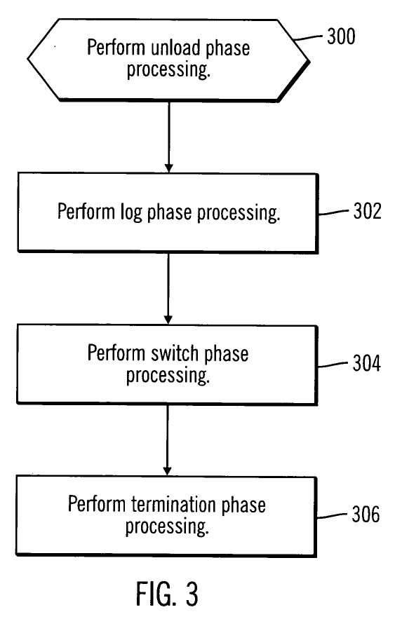

FIG. 3 illustrates processing for a reorganization of data in accordance with certain embodiments. Control begins at block 300 with the data reorganizer 132 performing unload phase processing to retrieve data from the original data set and insert the data into a shadow data set. In block 302, the data reorganizer 132 performs log phase processing to process log records. In block 304, the data reorganizer 132 performs switch phase processing to switch the reorganized shadow data set and the original data set. The switch phase processing begins when the log phase processing terminates. In block 306, the data reorganizer 132 performs termination phase processing to terminate the reorganization.

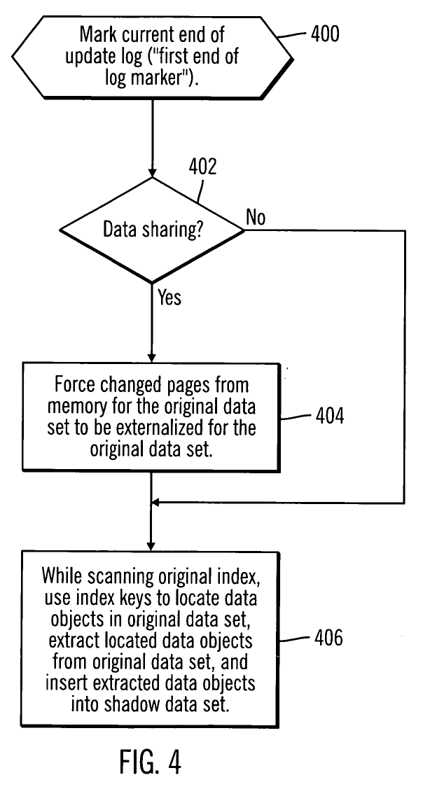

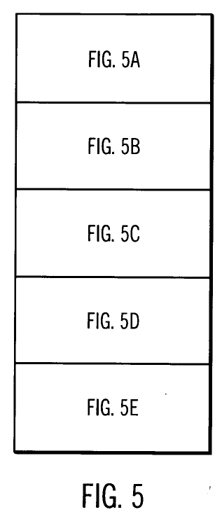

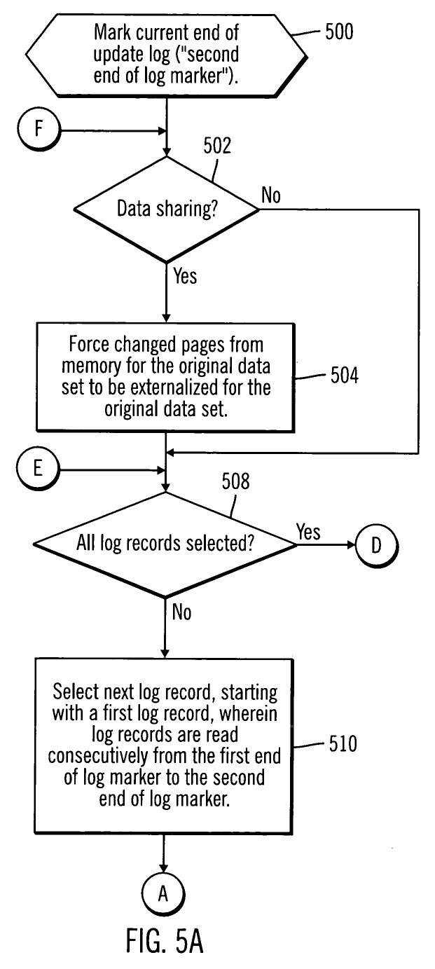

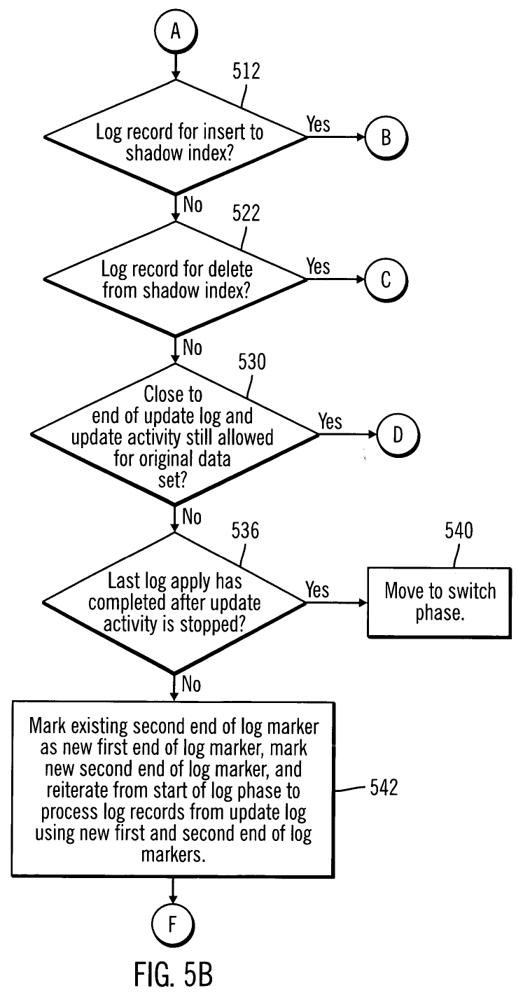

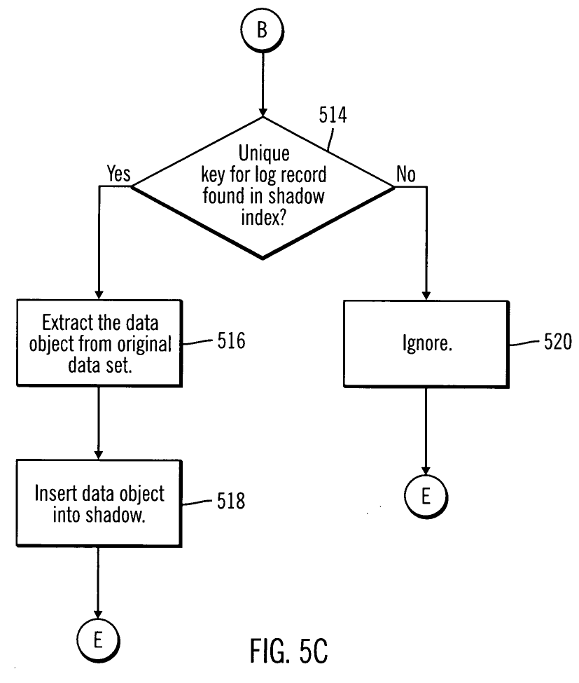

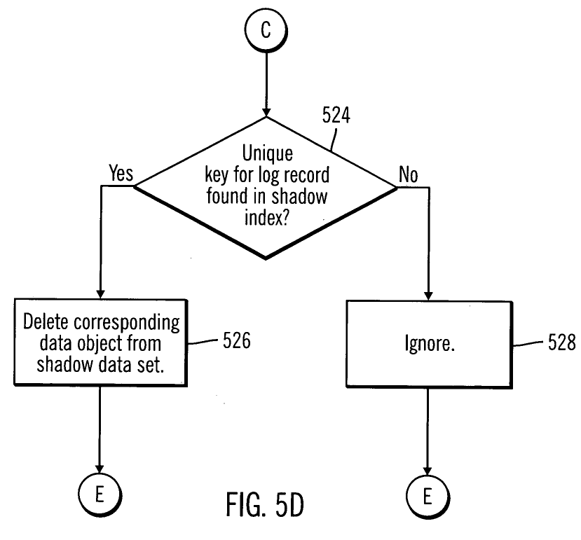

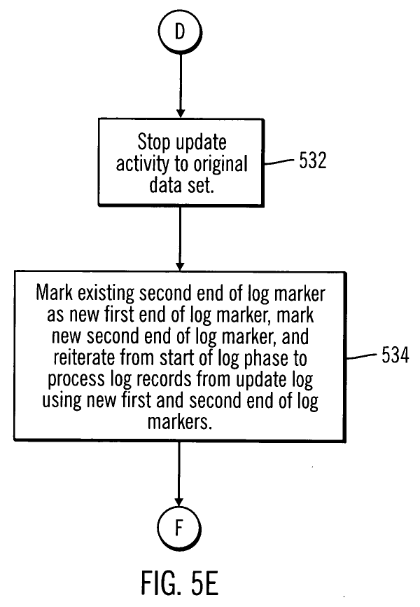

FIG. 4 illustrates unload phase processing in accordance with certain embodiments. Control begins at block 400 with the data reorganizer 132 marking a current end of an update log. In block 402, the data reorganizer 132 determines whether there is data sharing. Data sharing may be described as a state in which other data store managers may update the original data set at the same time that the data reorganizer 132 is accessing the original data set. If so, processing continues to block 404, otherwise, processing continues to block 406. In block 404, the data reorganizer 132 forces changed pages for all members participating in the data sharing of the original data set from memory for the original data set to be externalized for the original data set. Forcing the changed pages causes changes to the original data set that are stored in memory to be moved to the data store 170 in which the original data set is stored. Then, data objects from the original data set in the data store 170 are retrieved to the shadow data set. This is done in both the unload phase and the log phase to ensure that each complete data object is available to be retrieved from the original data set. The original data set has an associated original index (i.e., an index to the original data set). An index may be described as an ordered set of references (e.g., pointers) to data objects in a data set and is used to access each data object using an index key. In block 406, while scanning the original index, the data reorganizer 132 uses index keys to locate data objects in the original data set, retrieve the located data objects from the original data set, and insert the retrieved data objects into the shadow data set. While the retrieval is occurring in block 406, it is possible that other data managers are continuing to update the original data set. Therefore, several iterations of the log record processing (illustrated with reference to FIG. 5) may be performed to ensure that these changes are also captured while reorganizing the shadow data set.

FIG. 5 illustrates log phase processing in accordance with certain embodiments. FIG. 5 is shown as FIGS. 5A-5E. Control begins at block 500 with the data reorganizer 132 marking a current end of the update log. This is done in both the unload phase and the log phase. In block 502, the data reorganizer 132 determines whether there is data sharing. If so, processing continues to block 504, otherwise, processing continues to block 506. In block 504, the data reorganizer 132 forces changed pages for all members participating in the data sharing of the original data set from memory for the original data set to be externalized for the original data set.

In block 508, the data reorganizer 132 determines whether all log records have been selected. Each log record includes a unique key identifying a data object and an indication of an activity associated with that data object. In certain embodiments, each log record does not include data associated with the data object. If so, processing continues to block 532 (FIG. 5E), otherwise, processing continues to block 510. In block 510, the data reorganizer 132 selects the next log record, starting with a first log record, wherein log records are read consecutively from the first end of log marker to the second end of log marker. From block 510 (FIG. 5A), processing continues to block 512 (FIG. 5B). In block 512, the data reorganizer 132 determines whether the selected log record is for an insert to the original index (i.e., whether a data object was inserted into the original data set, and an index entry in the original index indicates a key to the changed data object in the original data set). If so, processing continues to block 514 (FIG. 5C), otherwise, processing continues to block 522 (FIG. 5B).

In block 514, the data reorganizer 132 determines whether a unique key for the log record is found in a shadow index (i.e., an index to the shadow data set). If so, processing continues to block 516, otherwise, processing continues to block 520. In block 516, the data reorganizer 132 retrieves the data object from the original data set. In block 518, the data reorganizer 132 inserts the data object into the shadow data set. From block 518 (FIG. 5C), processing continues to block 508 (FIG. 5A). In block 520, the data reorganizer 132 ignores the insert. From block 520 (FIG. 5C), processing continues to block 508 (FIG. 5A).

In certain embodiments, such as those in which a data object is a LOB, when the data object is to be updated, the data object is deleted and then a modified data object is inserted.

Returning to FIG. 5B, in block 522, the data reorganizer 132 determines whether the selected log record is for a delete from the original index (i.e., whether a data object was deleted from the original data set, and an index entry in the original index identifies the deletion). If so, processing continues to block 524 (FIG. 5D), otherwise, processing continues to block 530 (FIG. 5B). In block 524, the data reorganizer 132 determines whether a unique key for the log record is found in the shadow index. If so, processing continues to block 526, otherwise, processing continues to block 528. In block 526, the data reorganizer 132 deletes a corresponding data object from the shadow data set. Thus, if a log record is found for a delete from the index, no access to the original data set is needed. From block 526 (FIG. 5D), processing continues to block 508 (FIG. 5A). In block 528, the data reorganizer 132 ignores the delete. From block 528 (FIG. 5D), processing continues to block 508 (FIG. 5A).

Retuning to FIG. 5B, in block 530, the data reorganizer 132 determines whether it is close to the end of the update log (i.e., close to the second end of log marker) and whether update activity is still allowed for the original data set. In certain embodiments update activity may not be allowed if processing is close to the end of the update log. If so, processing continues to block 532 (FIG. 5E), otherwise, processing continues to block 536 (FIG. 5B). In block 532, the data reorganizer 132 stops update activity to the original data set. In block 534, the data reorganizer 132 marks the existing second end of log marker as a new first end of log marker, marks a new second end of log marker, and reiterates from the start of the log phase to process log records from the update log using new first and second end of log markers, and so processing continues at block 500. For example, if the existing first end of log marker is set to A, the second end of log marker is set to B, then the new first end of log marker is set to B, a new second end of log marker is set to C, and the data reorganizer 132 processes log records from B to C in the next iteration. There may be one (e.g., A to B) or more iterations of such log phase processing.

Returning to FIG. 5B, in block 536, the data reorganizer 132 determines whether the last log apply has completed after the update activity is stopped. If so, processing continues to block 540, otherwise, processing continues to block 542. In block 540, the data reorganizer 132 moves to the switch phase. In block 542, the data reorganizer 132 marks the existing second end of log marker as a new first end of log marker, marks a new second end of log marker, and reiterates from the start of the log phase to process log records from the update log using new first and second end of log markers, and so processing continues at block 500. For example, if the existing first end of log marker is set to A, the second end of log marker is set to B, then the new first end of log marker is set to B, a new second end of log marker is set to C, and the data reorganizer 132 processes log records from B to C in the next iteration. There may be one (e.g., A to B) or more iterations of such log phase processing.

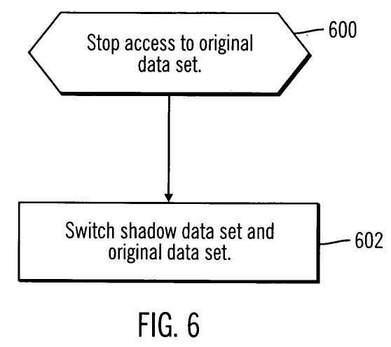

FIG. 6 illustrates switch phase processing in accordance with certain embodiments. Control begins in block 600 with the data reorganizer 132 stopping access to the original data set. In block 602, the data reorganizer 132 switches the shadow data set with the original data set. The switching may be performed by renaming the data sets or switching pointers that point to the original and shadow data sets.

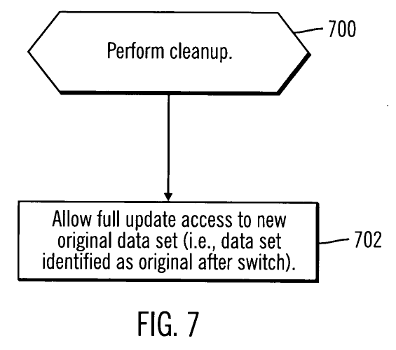

FIG. 7 illustrates termination phase processing in accordance with certain embodiments. Control begins in block 700 with the data reorganizer 132 performing clean up (e.g., deleting the old original data set and removing any restrictions on data access). In block 702, the data reorganizer 132 allows full update access to the new original data set (i.e., the data set identified as the original data set after the switch).

DB2 and z/OS are registered trademarks or common law marks of International Business Machines Corporation in the United States and/or other countries.

### Additional Embodiment Details

The described operations may be implemented as a method, computer program product or apparatus using standard programming and/or engineering techniques to produce software, firmware, hardware, or any combination thereof.

Each of the embodiments may take the form of an entirely hardware embodiment, an entirely software embodiment or an embodiment containing both hardware and software elements. The embodiments may be implemented in software, which includes but is not limited to firmware, resident software, microcode, etc.

Furthermore, the embodiments may take the form of a computer program product accessible from a computer-usable or computer-readable medium providing program code for use by or in connection with a computer or any instruction execution system. For the purposes of this description, a computer-usable or computer readable medium may be any apparatus that may contain, store, communicate, propagate, or transport the program for use by or in connection with the instruction execution system, apparatus, or device.

The described operations may be implemented as code maintained in a computer-usable or computer readable medium, where a processor may read and execute the code from the computer readable medium. The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a rigid magnetic disk, an optical disk, magnetic storage medium (e.g., hard disk drives, floppy disks, tape, etc.), volatile and non-volatile memory devices (e.g., a random access memory (RAM), DRAMs, SRAMs, a read-only memory (ROM), PROMs, EEPROMs, Flash Memory, firmware, programmable logic, etc.). Current examples of optical disks include compact disk—read only memory (CD-ROM), compact disk—read/write (CD-R/W) R/W) and DVD.

The code implementing the described operations may further be implemented in hardware logic (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

A computer program product may comprise computer useable or computer readable media, hardware logic, and/or transmission signals in which code may be implemented. Of course, those skilled in the art will recognize that many modifications may be made to this configuration without departing from the scope of the embodiments, and that the computer program product may comprise any suitable information bearing medium known in the art.

The term logic may include, by way of example, software, hardware, firmware, and/or combinations of software and hardware.

Certain implementations may be directed to a method for deploying computing infrastructure by a person or automated processing integrating computer-readable code into a computing system, wherein the code in combination with the computing system is enabled to perform the operations of the described implementations.

The logic of FIGS. 2, 3, 4, 5A-5E, 6, and 7 describes specific operations occurring in a particular order. In alternative embodiments, certain of the logic operations may be performed in a different order, modified or removed. Moreover, operations may be added to the above described logic and still conform to the described embodiments. Further, operations described herein may occur sequentially or certain operations may be processed in parallel, or operations described as performed by a single process may be performed by distributed processes.

The illustrated logic of FIGS. 2, 3, 4, 5A-5E, 6, and 7 may be implemented in software, hardware, programmable and non-programmable gate array logic or in some combination of hardware, software, or gate array logic.

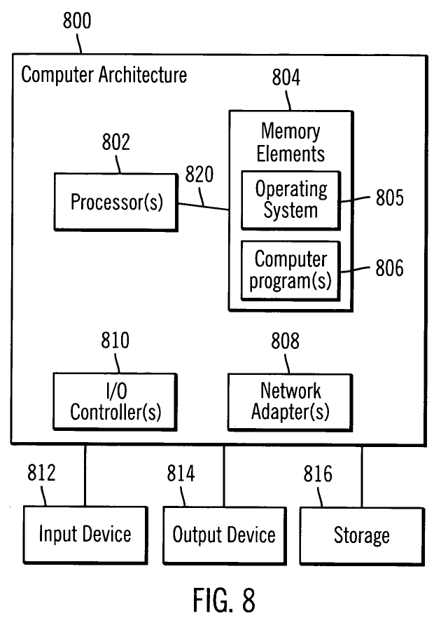

FIG. 8 illustrates a system architecture 800 that may be used in accordance with certain embodiments. Local computing device 100, storage controller 120, and/or remote backup system 130 may implement system architecture 800. The system architecture 800 is suitable for storing and/or executing program code and includes at least one processor 802 coupled directly or indirectly to memory elements 804 through a system bus 820. The memory elements 804 may include local memory employed during actual execution of the program code, bulk storage, and cache memories which provide temporary storage of at least some program code in order to reduce the number of times code must be retrieved from bulk storage during execution. The memory elements 804 may store an operating system 805 and one or more computer programs 806.

Input/output or I/O devices 812, 814 (including but not limited to keyboards, displays, pointing devices, etc.) may be coupled to the system either directly or through intervening I/O controllers 810.

Network adapters 808 may also be coupled to the system to enable the data processing system to become coupled to other data processing systems or remote printers or storage devices through intervening private or public networks. Modems, cable modem and Ethernet cards are just a few of the currently available types of network adapters 808.

The system architecture 800 may be coupled to storage 816 (e.g., a non-volatile storage area, such as magnetic disk drives, optical disk drives, a tape drive, etc.). The storage 810 may comprise an internal storage device or an attached or network accessible storage. Computer programs 806 in storage 810 may be loaded into the memory elements 804 and executed by a processor 802 in a manner known in the art.

The system architecture 800 may include fewer components than illustrated, additional components not illustrated herein, or some combination of the components illustrated and additional components. The system architecture 800 may comprise any computing device known in the art, such as a mainfiame, server, personal computer, workstation, laptop, handheld computer, telephony device, network appliance, virtualization device, storage controller, etc.

The foregoing description of embodiments of the invention has been presented for the purposes of illustration and description. It is not intended to be exhaustive or to limit the embodiments of the invention to the precise form disclosed. Many modifications and variations are possible in light of the above teaching. It is intended that the scope of the embodiments of the invention be limited not by this detailed description, but rather by the claims appended hereto. The above specification, examples and data provide a complete description of the manufacture and use of the composition of the embodiments of the invention. Since many embodiments of the invention may be made without departing from the spirit and scope of the embodiments of the invention, the embodiments of the invention reside in the claims hereinafter appended or any subsequently-filed claims, and their equivalents.

What is claimed is:

1. A method for reorganizing data, comprising:
retrieving data from an original data set and inserting the data into a shadow data set;
reading a log record from an update log, wherein the log record includes a unique key identifying a data object and an indication of an activity associated with that data object; and
performing the activity associated with the data object by determining whether the unique key is found in a shadow index for the shadow data set.

2. The method of claim 1, further comprising:
determining that the log record is for an update activity, wherein the update activity comprises a delete activity followed by an insert activity.

3. The method of claim 1, further comprising:
in response to determining that the log record is for an insert activity and that the unique key is found in the shadow index,
retrieving the data object from the original data set; and
inserting the data object into the shadow data set.

4. The method of claim 1, further comprising:
in response to determining that the log record is for a delete activity and that the unique key is found in a shadow index for the shadow data set, deleting the data object from the shadow data set.

5. The method of claim 1, wherein the log record does not include data associated with the data object.

6. The method of claim 1, further comprising:
receiving an update to the data object, wherein the update may consist of an insert activity, a delete activity or an update activity; and
logging the update with a unique key of the data object without including data associated with the data object in the log record.

7. The method of claim 1, further comprising:
determining that a last log apply has completed after update activity is stopped;
stopping access to the original data set; and
switching the original data set and the shadow data set.

8. The method of claim 7, further comprising:
performing clean up; and
allowing full update access to the original data set identified as the original data set after the switch.

9. The method of claim 1, wherein retrieving data fturther comprises:
while scanning an original index for the original data set, using index keys to locate data objects in the original data set, retrieve the located data objects from the original data set, and insert the retrieved data objects into the shadow data set.

10. The method of claim 1, further comprising:
determining that a last read log record is close to an end of the update log and update activity is still allowed for the original data set;
stopping update activity to the original data set; and
processing log records from the update log.

11. A computer program product comprising a computer useable medium including a computer readable program, wherein the computer readable program when executed on a computer causes the computer to:
retrieve data from an original data set and insert the data into a shadow data set;
read a log record from an update log, wherein the log record includes a unique key identifying a data object and an indication of an activity associated with that data object; and
perform the activity associated with the data object by determining whether the unique key is found in a shadow index for the shadow data set.

12. The computer program product of claim 11, wherein the computer readable program when executed on a computer causes the computer to:
determine that the log record is for an update activity, wherein the update activity comprises a delete activity followed by an insert activity.

13. The computer program product of claim 11, wherein the computer readable program when executed on a computer causes the computer to:
in response to determining that the log record is for an insert activity and that the unique key is found in the shadow index,
retrieve the data object from the original data set; and
insert the data object into the shadow data set.

14. The computer program product of claim 11, wherein the computer readable program when executed on a computer causes the computer to:
in response to determining that the log record is for a delete activity and that the unique key is found in a shadow index for the shadow data set, deleting the data object from the shadow data set.

15. The computer program product of claim 11, wherein the log record does not include data associated with the data object.

16. The computer program product of claim 11, wherein the computer readable program when executed on a computer causes the computer to:
receive an update to the data object, wherein the update may consist of an insert activity, a delete activity or an update activity; and
log the update with a unique key of the data object without including data associated with the data object in the log record.

17. The computer program product of claim 11, wherein the computer readable program when executed on a computer causes the computer to:
determine that a last log apply has completed after update activity is stopped;
stop access to the original data set; and
switch the original data set and the shadow data set.

18. The computer program product of claim 17, wherein the computer readable program when executed on a computer causes the computer to:
perform clean up; and
allow full update access to the original data set identified as the original data set after the switch.

19. The computer program product of claim 11, wherein, when retrieving data, the computer readable program when executed on a computer causes the computer to:
while scanning an original index for the original data set, use index keys to locate data objects in the original data set, retrieve the located data objects from the original data set, and insert the retrieved data objects into the shadow data set.

20. The computer program product of claim 11, wherein the computer readable program when executed on a computer causes the computer to:
determine that a last read log record is close to an end of the update log and update activity is still allowed for the original data set;
stop update activity to the original data set; and
process log records from the update log.

21. A system for reorganizing data, comprising:
logic capable of performing operations, the operations comprising:
retrieving data from an original data set and inserting the data into a shadow data set;
reading a log record from an update log, wherein the log record includes a unique key identifying a data object and an indication of an activity associated with that data object; and
performing the activity associated with the data object by determining whether the unique key is found in a shadow index for the shadow data set.

22. The system of claim 21, wherein the operations further comprise:
determining that the log record is for an update activity, wherein the update activity comprises a delete activity followed by an insert activity.

23. The system of claim 21, wherein the operations further comprise:
in response to determining that the log record is for an insert activity and that the unique key is found in the shadow index,
retrieve the data object from the original data set; and
insert the data object into the shadow data set.

24. The system of claim 21, wherein the operations further comprise:
in response to determining that the log record is for a delete activity and that the unique key is found in a shadow index for the shadow data set, deleting the data object from the shadow data set.

25. The system of claim 21, wherein the log record does not include data associated with the data object.

26. The system of claim 21, wherein the operations further comprise:
receiving an update to the data object, wherein the update may consist of an insert activity, a delete activity or an update activity; and
logging the update with a unique key of the data object without including data associated with the data object in the log record.

27. The system of claim 21, wherein the operations further comprise:
determining that a last log apply has completed after update activity is stopped;
stopping access to the original data set; and
switching the original data set and the shadow data set.

28. The system of claim 27, wherein the operations further comprise:
performing clean up; and
allowing fill update access to the original data set identified as the original data set after the switch.

29. The system of claim 21, wherein for retrieving data the operations further comprise:
while scanning an original index for the original data set, using index keys to locate data objects in the original data set, retrieve the located data objects from the original data set, and insert the retrieved data objects into the shadow data set.

30. The system of claim 21, wherein the operations further comprise:
determining that a last read log record is close to an end of the update log and update activity is still allowed for the original data set;
stopping update activity to the original data set; and
processing log records from the update log.
